(19) United States
(12) Patent Application Publication
(10) Pub. No.: US 2025/0371963 A1
(43) Pub. Date: Dec. 4, 2025

(54) REMOTE CONTROL OF A PARKED VEHICLE HAVING AN OCCUPANT OR PET BASED ON EXTERNAL NOISE

(71) Applicant: Volvo Car Corporation, Göteborg (SE)

(72) Inventors: Fredrik Törner, Göteborg (SE); Alexander Eriksson, Göteborg (SE); Derong Yang, Göteborg (SE); Viktor Larsson, Göteborg (SE); Anders Ödblom, Göteborg (SE)

(21) Appl. No.: 18/679,663

(22) Filed: May 31, 2024

(51) Int. Cl. G08B 21/24; B60W 50/00; G06V 20/59; G06V 40/10; G08B 3/10; G08B 21/02; G08B 21/22

(52) U.S. Cl. CPC G08B 21/24; B60W 50/0098; G06V 20/593; G06V 40/10; G08B 3/10; G08B 21/02; G08B 21/22; B60W 2050/0083; B60W 2420/403; B60W 2420/54

(57) ABSTRACT

A system for remote control of an occupied vehicle includes one or more external vehicle environmental sensors. The system further includes a suspect event identification module including instructions stored in at least one memory and executable by one or more processors to cause the passenger identification module to determine the occurrence of a suspect event at the occupied vehicle based, at least in part, on data indicative of an audio environment of a surrounding of the occupied vehicle. The system also includes a communication module including instructions stored in at least one memory and executable by one or more processors to cause the communication module to communicate an initial signal to a remote device of an operator of the occupied vehicle outside of the occupied vehicle in response to the determination of the suspect event.

### TECHNICAL FIELD

The present disclosure relates generally to the automotive field. More particularly, the present disclosure relates to facilitating communication between an occupied, parked vehicle and an operator device and/or providing corrective actions from a remote operator.

### BACKGROUND

Operators of vehicles often transport occupants whom, for a variety of reasons, may be left intentionally or unintentionally in a parked vehicle while the operator leaves the area of the vehicle to complete a task such as picking up groceries from a store, filling a script at a pharmacy, etc. Regardless of the reason for leaving the occupant(s) within the vehicle, some occupants may not be able to communicate to a well-intended good Samaritan that the occupant is safe within the vehicle, at least for the time being. For example, children, pets, people having physical or mental challenges, and the like may not be able to communicate with the good Samaritan. Thus, situations arise currently where vehicle windows are broken or emergency personal are contacted to rescue the occupant(s) that are otherwise safe and comfortable within the vehicle.

As such, a need exists in the art for a system and associated methods and control systems for vehicles that overcome the above limitations.

This background is provided as an illustrative contextual environment only. It will be readily apparent to those of ordinary skill in the art that the systems and methods of the present disclosure may be implemented in other contextual environments as well.

### SUMMARY

Therefore, it is an object of the present disclosure to provide a system for remote control of an occupied vehicle and associated methods of operation and control systems that overcome the limitations of the known art.

Embodiments of the disclosed systems and methods facilitate communication between an occupied vehicle and a remote device of an operator of the vehicle outside of the surroundings or immediate surroundings of the vehicle. A suspect event identification module and associated method elements can determine that a good Samaritan (pedestrian) has approached a door of the vehicle, that the pedestrian is observing an occupant of the vehicle, that the pedestrian is knocking on an exterior surface of the occupied vehicle such as a widow, and/or that the pedestrian is communicating or attempting to communicate with the occupant(s) of the vehicle based on external vehicle sensors. In several embodiments, an audio sensor(s) may be utilized to determine the occurrence of any of these events or other suspect events based on an audio environment of the surrounding of the occupied vehicle. Thereafter, a communication module can communicate a signal to the remote device of the operator of vehicle. In various embodiments and configurations, the suspect event identification module may only identify the suspect event and/or the signal may only be communicated to the remote device after determining that the vehicle is occupied. The signal communicated to the remote device may include an alert, an audio recording, an image, and/or a video recording of the surroundings of the vehicle or the pedestrian.

In some embodiments, the communication module may further receive a response signal communicated from the remote device indicating one or more corrective actions desired by the operator. For example, in the case that operator of vehicle is already aware of the occupant(s) and that the occupants are safe and comfortable (e.g., the AC has been left on with the car running), the corrective action may include playing a prerecorded message indicating the same or establishing a two-way communication between the remote device and the surrounding of the vehicle (e.g., an audio two-way communication and/or a communication including video such as at least video of the exterior of the vehicle). Alternatively, such two-way communication may be utilized to update the operator that the occupant(s) is not safe and/or comfortable within the vehicle. In the event that the occupant(s) is not safe and comfortable within the vehicle, the corrective action(s) may further or alternatively include one or more of opening a window of the vehicle, unlocking a door of the vehicle, activating a climate control system of the vehicle, or implementing a predetermined setting of the climate control system.

To achieve the foregoing and other objects and advantages, in one aspect, the present subject matter is directed to a system for remote control of an occupied vehicle. The system includes one or more external vehicle environmental sensors. The system further includes a suspect event identification module including instructions stored in at least one memory and executable by one or more processors to cause the passenger identification module to determine the occurrence of a suspect event at the occupied vehicle based, at least in part, on data indicative of an audio environment of a surrounding of the occupied vehicle. The system also includes a communication module including instructions stored in at least one memory and executable by one or more processors to cause the communication module to communicate an initial signal to a remote device of an operator of the occupied vehicle outside of the occupied vehicle in response to the determination of the suspect event.

In at least one embodiment, the instructions of the communication module, when executed by the processor(s), may further cause the communication module to receive a response signal communicated from the remote device subsequent to communicating the initial signal. The response signal may indicate one or more corrective actions to be performed by one or more components of the occupied vehicle. In an additional or alternative embodiment, the corrective action may include one or more of opening a window of the occupied vehicle, unlocking a door of the occupied vehicle, activating a climate control system of the occupied vehicle, or implementing a predetermined setting of the climate control system. In some such embodiments or different embodiments, the suspect event may include one or more of a pedestrian observing an occupant of the occupied vehicle, the pedestrian knocking on an exterior surface of the occupied vehicle, or the pedestrian communicating with the occupant of the occupied vehicle. Additionally or alternatively, the remote device may include one or more of a key fob, a mobile device, or a personal computer. In some further or different embodiments, determining the occurrence of the suspect event at the occupied vehicle may further include determining that the surrounding of the occupied vehicle is a suspect area.

In additional or alternative embodiments, the system may further include one or more external vehicle speakers. In some embodiments, the corrective action may include playing a prerecorded message via the external vehicle speaker(s). In additional or alternative embodiments, the external environmental environment sensor(s) may include one or more external vehicle microphones. In some such embodiments, the corrective action may include establishing a two-way communication link between the remote device and the surrounding of the occupied vehicle via the external vehicle speaker(s) and the external vehicle microphone(s). In a further or different embodiment, the external vehicle environmental sensor(s) may include one or more external vehicle cameras. Additionally or alternatively, the initial signal may include data indicative of an image or video of one or more of the suspect event, the surrounding of the occupied vehicle, or at least one pedestrian associated with the suspect event. In some such embodiments, the corrective action may include establishing a two-way communication link between the remote device and the surrounding of the occupied vehicle via the external vehicle speaker(s), the external vehicle microphone(s), and the external vehicle camera(s).

In some further or alternative embodiments, the system may further include one or more internal vehicle occupant sensors. In at least one such embodiment, the instructions of the suspect event module, when executed by the processor(s), may further cause the suspect event module to determine a status of the occupied vehicle as occupied based at least in part on a signal communicated from the internal vehicle occupant sensor(s). In some such embodiments, the initial signal may be communicated to the remote device subsequent to determining the status of the occupied vehicle as occupied. In some such embodiments or different embodiments, the initial signal may include data indicative of an image or video of one or more of an interior of the occupied vehicle or an occupant of the occupied vehicle.

In an additional or alternative aspect, the present subject matter is directed to a non-transitory computer-readable medium comprising instructions stored in at least one memory that, when executed by one or more processors, cause the one or more processors to carry out steps. The steps include determining a status of a parked vehicle as an occupied vehicle. The steps further include receiving a signal communicated from one or more external vehicle environmental sensors of the parked vehicle in response to the determination of the occupied vehicle. Another step includes determining the occurrence of a suspect event at the parked vehicle based, at least in part, on an audio environment of a surrounding of the parked vehicle indicated by the received signal. The steps also include communicating an initial signal to a remote device of an operator of the vehicle outside of the parked vehicle, in response to the determination of the suspect event.

In at least one embodiment, the steps may further include receiving a response signal communicated from the remote device subsequent to communicating the initial signal. The response signal may be indicative of one or more corrective actions to be performed. Additionally or alternatively, the steps may also include causing the corrective action(s) to be performed via one or more components of the parked vehicle. In some such embodiments or different embodiments, the corrective action(s) may include playing a prerecorded message via one or more external vehicle speakers of the parked vehicle. Additionally or alternatively, the corrective action(s) may include one or more of opening a window of the parked vehicle, unlocking a door of the parked vehicle, activating a climate control system of the parked vehicle, or implementing a predetermined setting of the climate control system. In further or alternative embodiments, the suspect event comprises at least one of a pedestrian observing an occupant of the parked vehicle, the pedestrian knocking on an exterior surface of the parked vehicle, or the pedestrian communicating with the occupant of the parked vehicle.

Additionally or alternatively, the external vehicle environmental sensor(s) may include one or more external vehicle microphones. In some such embodiments, the corrective action(s) may include establishing a two-way communication link between the remote device and the surrounding of the occupied vehicle via one or more external vehicle speakers and the external vehicle microphone(s). In an additional or alternative embodiment, the external vehicle environmental sensor(s) may include one or more external vehicle cameras. In some such embodiments, the initial signal may include data indicative of an image or video of one or more of the suspect event, the surrounding of the occupied vehicle, or at least one pedestrian associated with the suspect event. Additionally or alternatively, the corrective action(s) may include establishing a two-way communication link between the remote device and the surrounding of the occupied vehicle via the external vehicle microphone(s), the external vehicle camera(s), and the external vehicle speaker(s). In a further or different embodiment, the initial signal may include data indicative of an image or video of one or more of an interior of the occupied vehicle or an occupant of the occupied vehicle based on a signal communicated from one or more internal vehicle cameras.

In an additional or alternative aspect, the present subject matter is directed to a vehicle including one or more one external vehicle environmental sensors and one or more internal vehicle occupant sensors. The vehicle further includes a suspect event identification module including instructions stored in at least one memory and executable by one or more processors to cause the suspect event identification module to determine a status of the vehicle as occupied based at least in part on a signal communicated from the internal vehicle occupant sensor(s). The instructions of the suspect event identification module, when executed by the processor(s), may further cause the suspect event identification module to determine the occurrence of a suspect event at the vehicle based, at least in part, on data indicative of an audio environment of a surrounding of the vehicle. The vehicle also includes a communication module including instructions stored in at least one memory and executable by one or more processors to cause the communication module to communicate an initial signal to a remote device of an operator of the vehicle outside of the vehicle in response to the determination of the suspect event.

Embodiments of the invention can include one or more or any combination of the above features and configurations.

Additional features, aspects, and advantages of the invention will be set forth in the detailed description of illustrative embodiments that follows, and in part will be readily apparent to those skilled in the art from that description or recognized by practicing the invention as described herein. It is to be understood that both the foregoing general description and the following detailed description present various embodiments of the invention and are intended to provide an overview or framework for understanding the nature and character of the invention as it is claimed. The accompanying drawings are included to provide a further understanding of the invention and are incorporated in and constitute a part of this specification.

### BRIEF DESCRIPTION OF THE DRAWINGS

A full and enabling disclosure of the present invention, including the best mode thereof, directed to one of ordinary skill in the art, is set forth in the specification, which makes reference to the companying drawings, in which:

FIG. 1 illustrates a schematic diagram of an exemplary embodiment of a system for remote control of an occupied vehicle, in accordance with aspects of the present subject matter;

FIG. 2 illustrates a schematic logic diagram of an exemplary embodiment of a system for remote control of an occupied vehicle, in accordance with aspects of the present subject matter;

FIG. 3 illustrates an exemplary embodiment of a method for remote control of an occupied vehicle, in accordance with aspects of the present subject matter;

FIG. 4 illustrates a schematic diagram of an exemplary embodiment of a network of a cloud-based system for implementing various cloud-based services, in accordance with aspects of the present subject matter;

FIG. 5 illustrates a schematic diagram of an exemplary embodiment of a server which may be used in the cloud-based system of FIG. 4 or stand-alone, in accordance with aspects of the present subject matter; and

FIG. 6 illustrates a schematic diagram of an exemplary embodiment of a user device which may be used in the cloud-based system of FIG. 4 or stand-alone, in accordance with aspects of the present subject matter.

It will be readily apparent to those of ordinary skill in the art that aspects of illustrated embodiments may be used in any desired combinations, without limitation. Repeat use of reference characters in the present specification and drawings is intended to represent the same or analogous features or elements of the present invention.

### DETAILED DESCRIPTION

The present invention will now be described more fully hereinafter with reference to the accompanying drawings in which exemplary embodiments of the invention are shown. However, the invention may be embodied in many different forms and should not be construed as limited to the representative embodiments set forth herein. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. It is envisioned that other embodiments may perform similar functions and/or achieve similar results. Any and all such equivalent embodiments and examples are within the scope of the present invention and are intended to be covered by the appended claims.

The exemplary embodiments are provided so that this disclosure will be both thorough and complete and will fully convey the scope of the invention and enable one of ordinary skill in the art to make, use, and practice the invention. The word “exemplary” is used herein to mean “serving as an example, instance, or illustration.” Any implementation described herein as “exemplary” is not necessarily to be construed as preferred or advantageous over other implementations.

The terms “coupled,” “fixed,” “attached to,” “communicatively coupled to,” “operatively coupled to,” and the like refer to both direct coupling, fixing, attaching, communicatively coupling, and operatively coupling as well as indirect coupling, fixing, attaching, communicatively coupling, and operatively coupling through one or more intermediate components or features, unless otherwise specified herein. “Communicatively coupled to” and “operatively coupled to” can refer to physically and/or electrically related components.

As used herein, the terms “first”, “second”, and “third” may be used interchangeably to distinguish one component from another and are not intended to signify location or importance of the individual components. The singular forms “a”, “an”, and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 1, 2, 4, 10, 15, or 20 percent margin.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

Again, embodiments of the disclosed systems and methods facilitate communication between an occupied vehicle and a remote device of an operator of the vehicle outside of the surroundings or immediate surroundings of the vehicle. A suspect event identification module and associated method elements can determine that a pedestrian has approached a door of the vehicle, that the pedestrian is observing an occupant of the vehicle, that the pedestrian is knocking on an exterior surface of the occupied vehicle such as a widow, and/or that the pedestrian is communicating or attempting to communicate with the occupant(s) of the vehicle based on external vehicle sensors. In several embodiments, audio sensor(s), microphone(s), or the like may be utilized to determine the occurrence of any of these events or other suspect events based on an audio environment of the surrounding of the occupied vehicle. Thereafter, a communication module can communicate a signal to the remote device of the operator of vehicle. In various embodiments and configurations, the suspect event identification module may only identify the suspect event and/or the signal may only be communicated to the remote device after determining that the vehicle is occupied. The signal communicated to the remote device may include an alert, an audio recording, an image, and/or a video recording of the surroundings of the vehicle or the pedestrian.

In various situations and configurations, the communication module may further receive a response signal communicated from the remote device indicating one or more corrective actions desired by the operator. For example, in the case that operator of vehicle is already aware of the occupant(s) and that the occupants are safe and comfortable (e.g., the AC has been left on with the car running), the corrective action may include playing a prerecorded message indicating the same or establishing a two-way communication between the remote device and the surrounding of the vehicle (e.g., an audio two-way communication and/or a communication including video such as at least video of the exterior of the vehicle). Alternatively, such two-way communication may be utilized to update the operator that the occupant(s) is not safe and/or comfortable within the vehicle. In the event that the occupant(s) is not safe and comfortable within the vehicle, the corrective action(s) may further or alternatively include one or more of opening a window of the vehicle, unlocking a door of the vehicle, activating a climate control system of the vehicle, or implementing a predetermined setting of the climate control system.

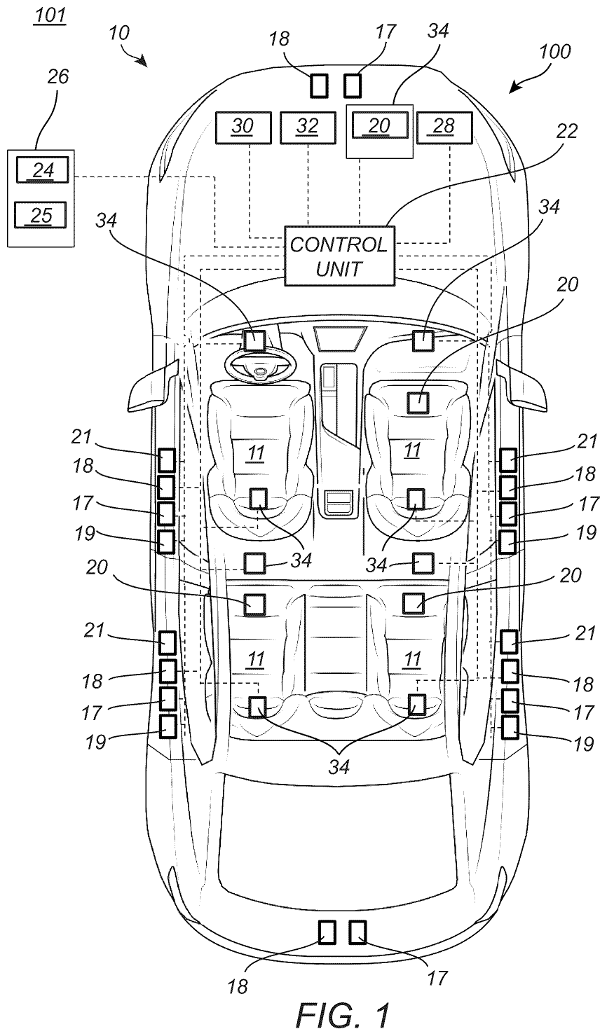

Referring now generally to FIG. 1, a schematic diagram of an exemplary embodiment of a system for remote control of an occupied vehicle is illustrated in accordance with aspects of the present subject matter. As shown, a vehicle 10 may generally include a system 100 for controlling and/or managing the operation of one or more components of the vehicle 10 upon the detection of a suspect event surrounding the vehicle 10 and in response to instructions/inputs received from a remote operator of the vehicle 10, as will be explained in more detail in the following description. While the exemplary illustration of FIG. 1 shows an empty vehicle 10 (e.g., without an occupant such as a child, pet, etc.), embodiments of the system 100 disclosed herein may be particularly useful in situations where a vehicle is temporarily parked with such an occupant while the operator of the vehicle runs an errand (e.g., picking up milk from a store, filling a prescription, paying for parking, etc.). Particularly, embodiments of the disclosed system 100 may alleviate issues presented when the operator leaves such an occupied vehicle 10 unsupervised for a brief period of time and a well-intended good Samaritan unnecessarily attempts to rescue the occupant.

As shown, the vehicle 10 generally includes a plurality of seats, seat assemblies, occupant suites, or the like (seat assemblies 11 of FIG. 1). As further illustrated, the vehicle 10 and/or system 100 may include one or more one or more internal vehicle occupant sensors such as seat pressure sensors, microphones, cameras, and the like (internal sensor(s) 34) and/or one or more external vehicle environmental sensors such as microphones, cameras, and the like (external sensor(s) 18), as described in more detail herein. In various embodiments and as shown, the vehicle 10 and/or system 100 may include one or more external vehicle speakers (external speakers 17).

While each seat assembly 11 of FIG. 1 is illustrated with one or more dedicated internal sensor(s) 34 (e.g., microphones, cameras, seat sensors, etc.), some vehicles 10 and/or systems 100 may not include a multiple internal sensors 34 for each seat assembly 11. For example, only a portion of the seat assemblies 11 may be provided with a dedicated microphone, such as some but not all of the rear seat assemblies 11. In some embodiments, adjacent seat assemblies 11 may share a microphone and/or a camera configured for use with embodiments of the system 100 described herein. In the illustrated embodiment, each door of the vehicle 10 and the front and back of the vehicle 10 includes a dedicated external speaker 17 and external sensor 18. However, other embodiments of the vehicle 10 and/or system 100 may include more or fewer of the external speakers 17 and/or external sensors 18. For example, some embodiments may include a single bird's-eye-view camera and/or a single microphone at a central location (e.g., the roof of the vehicle 10), omitted from FIG. 1 for clarity. Alternatively or additionally, doors of the vehicle 10 adjacent to one another may share one or more external speaker 17 and/or external sensor 18. For example, a single microphone or camera may be configured to capture the environment around both the front and rear driver side doors. Furthermore, a single speaker 17 may be provided for the driver-side of vehicle 10, and another single speaker may be provided for the passenger-side of the vehicle 10. Furthermore, some embodiments of the vehicle 10 and/or system 100 may not include the front external speaker 17, the front external sensor 18, the rear external speaker 17, and/or the rear external sensor 18.

Furthermore, at least some of the occupants seated within the vehicle 10, such as each occupied seat assembly 11 occupied by a human may be associated with a mobile device 20 (e.g., a cellular phone, tablet, laptop, MP4/MP3 audio device, or the like). Embodiments of the system 100 disclosed herein may utilize the mobile device(s) 20 of the occupants to determine that the vehicle 10 is occupied. Thus and in such embodiments, the internal sensor(s) 34 may include one more receivers/transceivers suitable to establish a wired or wireless connection (e.g., a local area network connection, a Wi-Fi connection, a Bluetooth connection, or the like) between the vehicle 10, the system 100, and/or an associated control unit 22 and the mobile device(s) 20 of the occupant(s).

In some embodiments, the vehicle 10 may be an electric vehicle having electrical components (e.g., batteries) for propelling the vehicle 10. Alternatively, the vehicle 10 may be configured with a rear-mounted or front-mounted internal combustion engine. In other embodiments, the vehicle 10 may be configured as a hybrid vehicle, which is driven by both a petroleum product (e.g., gas, diesel, jet fuel, and the like) and electrical power. It will be appreciated that the exemplary vehicle(s) 10 depicted and described herein are by way of example only, and, in other exemplary embodiments, the vehicle 10 may have any other suitable configuration, including, for example, any other suitable number of rows of seats, rows of doors, etc. and associated internal sensors 34. Similarly, the vehicle 10 may have any other suitable number and position of doors, external speakers 17, external sensors 18, and the like. Additionally or alternatively, in other exemplary embodiments, any other suitable power sources may be provided. For example, the vehicle 10 may include a liquid or gaseous hydrogen powered engine, a gas turbine engine, an inboard motor, an outboard motor, etc.

While embodiments of the vehicle 10 herein may be illustrated or described as an automotive vehicle, it should be appreciated that the present disclosure is equally applicable to any other form of transportation (e.g., trains, rotary-wing aircraft, fixed-wing aircraft, boats, busses, passenger rail cars, and the like) where remote control of an occupied vehicle by the operator and/or components included or associated with the occupied vehicle is desired or required. Thus, regardless of the type of power train, design, or model of the vehicle 10, the vehicle 10 may include or be utilized with embodiments of the system 100, as described herein.

As shown, the vehicle and/or system 100 may further include a control unit 22 (e.g., an electronic control unit, multiple associated control units, and/or a combination of one or more processing devices and at least one memory or memory device as described herein) communicatively coupled to the external speaker(s) 17, the external sensor(s) 18, the internal sensor(s) 34, the mobile device(s) 20 of the occupant(s), and/or other components of the vehicle 10 and/or system 100, such as an operator remote device (operator device 24), described in more detail in the following description. The control unit 22 may be configured to direct operation of one or more of such components in accordance with aspects of the present subject matter. While a single control unit 22 is illustrated in FIG. 1 for simplicity, it should be appreciated that the control unit 22 may include multiple associated control units that together are configured to provide operational the vehicle 10, the system 100, the external speaker(s) 17, the external sensor(s) 18, the internal sensor(s) 34, the mobile device(s) 20, the operator device 24, and/or other components of the vehicle 10 and/or system 100. The control unit 22 may additionally or alternatively facilitate communication between the operator device 24 and the vehicle 10, the system 100, an exterior of the vehicle 10, the external speaker(s) 17, the external sensor(s) 18, the internal sensors 34, internal speakers (omitted from FIG. 1) of the vehicle 10, and/or internal screens, touchscreens, displays, or the like of the vehicle 10.

Generally, the control unit 22 may be configured to receive a signal or data indicative of an environment surrounding the vehicle 10, such as an audio environment, and determine a suspect event (e.g., an event where a remote operator would desire to control one or more components of the vehicle 10). The control unit 22 may, in some embodiments, receive a signal or data indicative of the interior of the vehicle 10 and determine that vehicle is occupied. In various embodiments, the control unit 22 will not determine the presence of suspect events if the vehicle 10 is unoccupied. In other embodiments, suspect events may be recognized regardless of the whether the vehicle 10 is occupied. The control unit 22 may communicate an initial signal to the operator device 24 (e.g., the device of the operator outside of the vehicle 10 and the vehicle's immediate surroundings) once a suspect event is determined. The control unit 22 may then receive a response signal communicated from the remote device indicating one or more corrective actions to be performed by the vehicle 10, the system 100, the control unit 22, and/or one or more components or sub-systems of the preceding, as described herein. For example, the control unit 22 may establish a two-way communication link between the operator device 24 and the surroundings of the vehicle 10, e.g., the external speaker(s) 17 and/or the external sensor(s) 18 such as microphones, cameras, etc.

Thus and as shown in FIG. 1., the control unit 22 may provide operational control of the external speaker(s) 17, the external sensor(s) 18, and/or the internal sensor(s) 34 associated with vehicle 10, the system 100, and/or may be communicatively coupled with various additional or alternative components of the vehicle 10 or components associated with the vehicle 10 to similarly provide operational control, as described in more detail below. While some communication links in FIG. 1 may be illustrated as joint communication links, it should be appreciated that one or more components communicatively coupled to the control unit 22, such as all of the components, may have component dedicated communication links (e.g., wireless or wired communication links with the control unit 22).

The control unit 22 may include or be communicatively coupled with one or more external devices 26 such as the operator device 24 mentioned above. The operator device 24 may communicate inputs to the control unit(s) 22 utilized to control operation of the vehicle 10, the system 100, and/or one or more included or associated components or subcomponents such as the external speaker(s) 17, the external sensor(s) 18, and/or the internal sensor(s) 34. Embodiments of the operator device 24 may be configured as one or more of a key fob, a mobile device (e.g., a cell phone, a tablet, a personal digital assistant, wearable technology, a smart watch, smart glasses or sunshades, or the like), or a personal computer such a laptop or a desktop. As also shown in FIG. 1, the external device(s) 26 communicatively coupled to the control unit(s) 22 may include one or more additional remote devices (one additional device 25 illustrated in FIG. 1) such as additional or alternative operator devices 24, remote servers, processing units, memory devices, computing devices, or the like.

By applying an appropriate algorithm in the control unit 22, the system 100 can be integrated with the rest of the vehicle systems, with input from/output to a vehicle climate control system 28, a vehicle power supply 30, an infotainment unit or system (infotainment unit 32), the external speaker(s) 17, the external sensor(s) 18, the internal sensor(s) 34, one or more window actuators 19, and/or one or more door lock actuators 21, and/or devices such as the external device(s) 26 (e.g., one or more operator devices 24) and/or the mobile device(s) 20. In several embodiments some of such devices, such as all of such devices may each include a mobile application and/or a cloud application configured to provide external information and/or instructions to the control unit 22, as described in more detail herein.

In some embodiments, besides controlling the operation of the vehicle 10, system 100, and/or included or associated components thereof, the control unit 22 may also provide useful information to the operator via the operator device 24 such as a display or touch screen thereof. The user interface of the operator device 24 may include one or more buttons, switches, touch screen capability, or the like allowing an operator outside of the immediate surroundings of the vehicle 10 to communicate inputs to the control unit 22 utilized to control operation of the vehicle 10, system 100, and/or components or subsystems thereof, such as the external speaker(s) 17, the external sensor(s) 18, the climate control system 28, the vehicle power supply 30, the window actuator(s) 19, and/or the door lock actuator(s) 21.

As shown, the system 100 and/or vehicle 10 may include one or more seat sensors (e.g., internal sensor(s) 34), such as one seat sensor associated with each seat assembly 11 of the vehicle 10. Some embodiments of the seat sensor may include a sensor, circuit, or the like suitable to communicate a signal indicative of whether the associated seat assembly 11 is occupied or empty. For example, a suitable seat sensor may be configured to communicate a signal indicating pressure or weight on the seat, which may indicate at occupied seat assembly 11. Additionally or alternatively, a suitable seat sensor may be configured to communicate a signal indicating use of an associated seat belt, which may indicate an occupied seat assembly 11. As shown, the vehicle 10 and/or system 100 may include one or more additional or alternative internal sensors 34 for the interior of the vehicle 10, some of the seat assemblies 11, and/or all of the seat assemblies 11. For example, suitably configured microphones and/or cameras may be able to capture data indicating whether any of the seat assemblies are occupied. Thus, the internal sensor(s) 34 may include, without limitation, one or more audio sensors, microphones, optical sensors, cameras, RADAR sensors, LIDAR sensors, inferred sensors, other sensors suitable to transmit and/or receive suitable electromagnetic signals/waves, acoustic sensors, RFID transceivers/receivers, proximity sensors, seat sensors (e.g., a weight sensor embedded or provided in association with the seat 11), and/or the like.

With respect to the external sensor(s) 18, such sensors 18 may generally be configured to communicate one or more signals indicative of, without limitation, that a pedestrian has approached an associated door of the vehicle 10; that the pedestrian is observing an occupant of the vehicle, that the pedestrian knocking on an exterior surface of the occupied vehicle such a widow, and/or that the pedestrian is communicating or attempting to communicate with an occupant of the vehicle 10. Thus, the external sensor(s) 18 may include, without limitation, one or more audio sensors, microphones, optical sensors, cameras, RADAR sensors, LIDAR sensors, inferred sensors, other sensors suitable to transmit and/or receive suitable electromagnetic signals/waves, acoustic sensors, RFID transceivers/receivers, proximity sensors, and/or the like.

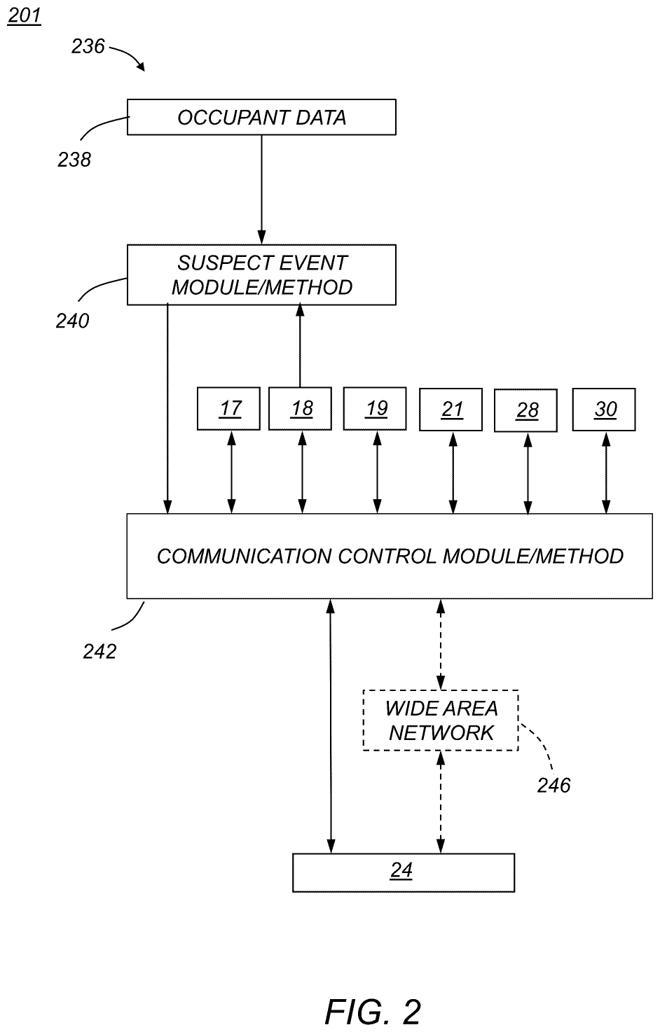

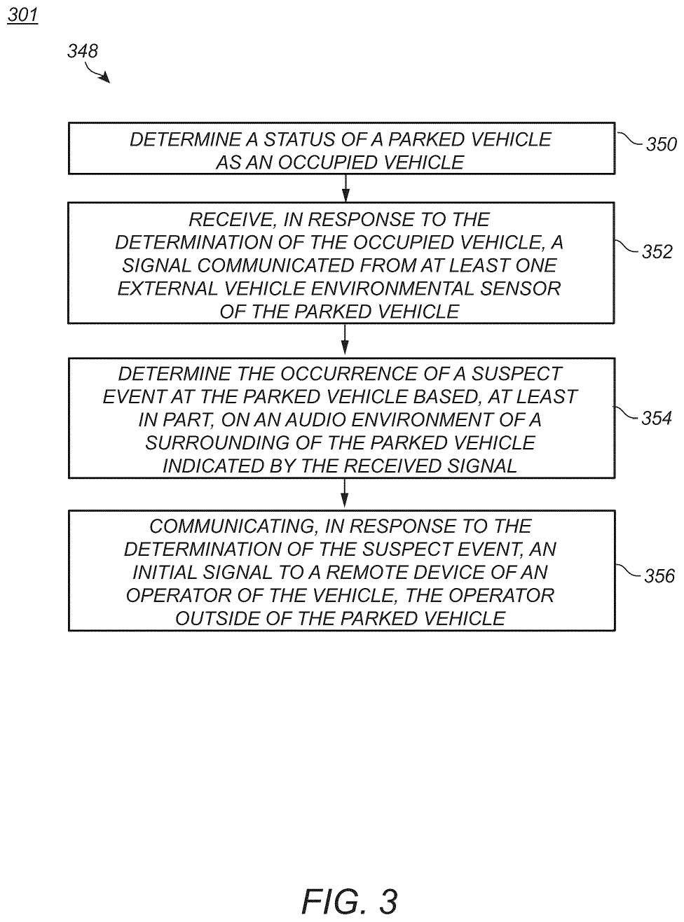

Referring now to FIGS. 2-3, FIG. 2 illustrates a schematic logic diagram of an exemplary embodiment of a system for remote control of an occupied vehicle, in accordance with aspects of the present subject matter, and FIG. 3 illustrates one exemplary embodiment of a method for remote control of an occupied vehicle. The logic diagram depicted in FIG. 2 (control logic 236) and/or the method or process (method 348) depicted in FIG. 3 may be utilized to control or in association with embodiments of the vehicle 10 and/or the system 100 as described above with respect to FIG. 1, any of the components or subsystems thereof such as the external speaker(s) 17, the external sensor(s) 18, the control unit 22, the mobile device(s) 20, the additional device(s) 25, the internal sensor(s) 34, the window actuator(s) 19, the door lock actuator(s) 21, vehicle climate control system 28, a vehicle power supply 30, and the operator device 24. However, it should be appreciated that the control logic 236 and/or the method 348 may be utilized to control or in association with embodiments of other similar or suitably configured vehicles, systems for remote control of an occupied vehicle, and/or components or subsystems thereof. The control logic 236 may include one or more modules including instructions stored in at least one memory and executable by one or more processors to cause the processor(s) to implement steps, method elements, or the like as described herein. For example, elements of the control logic 236 and/or method 348 may be implemented, at least in part, by the control unit 22 and stored in memory associated with the control unit 22 and/or included with or accessible by the vehicle 10.

As shown, the control logic 236 may include a suspect event identification module and/or method (suspect event module 240) configured to determine whether the vehicle 10 is occupied and/or the occurrence of a suspect event at the vehicle 10 or its immediate surroundings. Determining whether the vehicle 10 is occupied may be based on occupant data 238, e.g., sensed or provided via the internal sensor(s) 34 (FIG. 1). Determining the occurrence of a suspect event may be based on data and/or signals communicated from the external sensor(s) 18, such as one or more exterior microphones of the vehicle 10 and/or system 100. In at least one configuration, the method 348 may include and/or the suspect event module 240 may be configured to determine a status of the vehicle 10 as an occupied vehicle, see method element 350. Determining whether the vehicle 10 is occupied may be based at least in part on a signal communicated from the internal sensor(s) 34. In some situations and/or embodiments, occupant data 238 may include an indication that the system 100 and/or control unit 22 has been communicatively coupled to one or more mobile devices 20 of current, human occupants. Thus, the coupling of the control unit 22 with the mobile device(s) 20 may indicate, at least, that the vehicle 10 is occupied and/or a minimum number of occupants of the vehicle 10. It should be appreciated that, if the vehicle 10 is determined to be empty, the method 348 and/or process of the suspect event module 240 may end.

It should further be appreciated that various embodiments of the method 348 and/or disclosed system 100 are primarily directed to providing remote control of an occupied vehicle 10, and there is no need to monitor the vehicle 10 and/or its surroundings for suspect events if the vehicle 10 is unoccupied. Thus, the method 348 may include and/or the suspect event module 240 may be configured to receive a signal communicated from the external sensor(s) 18 of the vehicle 10 in response to the determination of the occupied vehicle, see method element 352. In some embodiments, the external sensor(s) 18 may include one or more microphones or the like suitable to capture an audio environment of a surrounding of the parked, occupied vehicle 10 (e.g., an immediate surrounding of the vehicle, such as within five feet of the vehicle 10, such as within three feet of the vehicle 10).

As further illustrated and in some embodiments, the method 348 may include and/or the suspect event module 240 may be configured to determine the occurrence of a suspect event at the parked, occupied vehicle 10 based, at least in part, on the audio environment of the surrounding of the vehicle 10, as indicated by the signal received from the external sensor(s) 18 (e.g., a microphone(s), an audio sensor(s), an acoustic sensor, or the like) see, e.g., method element 354. Additionally or alternatively, visual external sensor(s) 18 may be utilized to determine the occurrence of a suspect event at the parked, occupied vehicle 10 based, at least in part, on the visual environment of the surrounding of the vehicle 10, as indicated by the external sensor(s) 18 (e.g., an optical sensor(s), a camera(s), a RADAR sensor(s), a LIDAR sensor(s), an inferred sensor(s), a proximity sensor(s), a sensor(s) suitable to transmit and/or receive suitable electromagnetic signals/waves, and/or the like).

A suspect event, as utilized herein, may include, without limitation, a pedestrian approaching a door of the vehicle 10; the pedestrian observing an occupant of the vehicle 10, the pedestrian knocking on an exterior surface of the occupied vehicle 10, such a widow, and/or the pedestrian communicating or attempting to communicate with the occupant of the vehicle 10. Thus, the method 348 may include and/or the suspect event module 240 may be configured to determine the occurrence of suspect events in the surrounding of the vehicle 10, such as the immediate surrounding of the vehicle 10, e.g., within five feet of the vehicle 10, e.g., within three feet of the vehicle 10. In some embodiments, the occurrence of the suspect event at the occupied vehicle may be based, at least in part, based on a determination that the surrounding of the occupied vehicle is a suspect area, e.g., a high-crime area. In such embodiments, the external sensor(s) 18 may include one or more sensors suitable to determine a current geographical location of the vehicle, e.g., a global position system (GPS), a GPS sensor, or the like.

Additionally or alternatively, the method 348 may include and/or the suspect event module 240 may be configured to determine the occurrence of a suspect event at the parked, occupied vehicle 10 utilizing one or more suitable artificial intelligence algorithm, e.g., the suspect event module 240 and/or associated method 348 may include or be associated with one or more artificial intelligence programs. For example, the occurrence of the suspect event within the surrounding of the vehicle 10 and/or the position of the suspect event within the surrounding of the vehicle 10 or relative to the vehicle 10 may be determined utilizing the artificial intelligence algorithm(s) and based on the signals communicated from the external sensor(s) 18.

The artificial intelligence algorithms(s) may include one or more algorithms, programs, modules, and the like suitable to simulate intelligence human behavior or perform tasks historically requiring human implementation. For example, the artificial intelligence algorithms may include, without limitation, one or more of machine learning algorithms, artificial neural networks, recurrent artificial neural networks, feedforward neural networks, convolutional neural networks, recurrent neural networks, deep neural networks, natural language processing algorithms, long short term memory networks, inductive logic programming algorithms, support vector machines, clustering algorithms, Bayesian networks, reinforcement learning algorithms, representation learning algorithms, similarity and metric learning algorithms, sparse dictionary learning algorithms, genetic algorithms, k-nearest neighbor (KNN) algorithms, decision tree learning algorithms, association rule learning algorithms, and the like. Some of the artificial intelligence algorithms described herein may be trained (via a supervised or unsupervised training process) based on training data provided to the artificial intelligence algorithms. Thus, the artificial intelligence algorithm(s) may generally be utilized to determine the occurrence of the suspect event within the surrounding of the vehicle 10 and/or the position of the suspect event within the surrounding of the vehicle 10 or relative to the vehicle 10.

Referring again generally to FIGS. 2-3, the control logic 236 may include a communication control module and/or method (communication control module 242) configured to alert the operator of the occupied, parked vehicle 10 outside of the vehicle 10 and/or the surrounding of the vehicle 10 of the occurrence of the suspect event and/or provide relative information, (e.g., locations, pictures, videos, audio recordings, and the like) via the remote device 24. The communication control module 242 and/or associated steps of the method 348 may be configured to receive one or more commands (corrective actions) from the operator via the remote device 24 and to execute the corrective actions. Such corrective action may generally include playing an audio message to the surrounding of the vehicle 10, establishing a communication link between the remote device 24 and the surrounding of the vehicle 10, and/or controlling the operation of components or a subsystem of the vehicle 10 (e.g., the external sensor(s) 18, the external speaker(s) 17, the window actuators 19, the door lock actuators 21, the climate control system 28, and/or the vehicle power supply 30).

For example, the method 348 may include and/or the communication control module 242 may be configured to communicating an initial signal to the remote device 24 of the operator of the vehicle 10 outside of the parked vehicle 10 in response to the determination of the suspect event, see, e.g., method element 356. In some such embodiments, the initial signal is only communicated to the remote device 24 after determining the status of the parked vehicle 10 as occupied. Additionally or alternatively, the initial signal may generally indicate the occurrence of the suspect event and/or the position of the suspect even within the surrounding of the vehicle 10 or relative to the vehicle 10. The initial signal may further or alternatively indicate what kind of suspect event has occurred (e.g., a pedestrian knocking on a window or approaching and lingering around the vehicle 10). In various embodiments, the remote device 24 may provide an alert, alarm, or the like to the remote occupant in response to receiving the initial signal. In at least some embodiments, the initial signal may include data indicative of an image or video of the suspect event, the surrounding of the occupied vehicle 10, and/or the pedestrian(s) associated with the suspect event. In additional or alternative embodiments, the initial signal may include data indicative of an image or video of an interior of the occupied vehicle 10 or an occupant of the occupied vehicle 10. In various embodiments, the remote device 24 may be configured to play audio content or produce visual content included in the initial signal.

In some embodiments or alternative embodiments, the method 348 may include and/or the communication control module 242 may be configured to receiving a response signal communicated from the remote device 24 after communicating the initial signal. The response signal is generally indicative of one or more corrective actions to be performed by the vehicle 10, the system 100, and/or a component or subsystem thereof. For example, the response signal may indicate interface input provided via the remote device 24 (e.g., a button, dial, knob selection and/or a mobile device interface input with respect to a graphical user interface). For example, the operator may make a selection indicating that the operator wishes to initiate a two-way communication link with surrounding of the vehicle 10 or a pedestrian in the surrounding of the vehicle 10.

In several embodiments, the method 348 may include and/or the communication control module 242 may be configured to cause the corrective action(s) to be performed via the vehicle 10, the system 100, and/or at least one component or subsystem thereof. In one example, the corrective action(s) may include playing a prerecorded message via the external speaker(s) 17 of the parked vehicle 10. In additional or alternative embodiments, corrective action(s) may include opening a window of the parked vehicle 10 (e.g., via an associated window actuator 19), unlocking a door of the parked vehicle 10 (e.g., via an associated door lock actuator 21), activating a climate control system of the parked vehicle 10 (e.g., via the climate control system 28), and/or implementing a predetermined setting of the climate control system 28 of the parked vehicle 10. If necessary, the method 348 may include and/or the system 100 may be configured to transition the vehicle 10 from off to on, from standby to on, or the like via the vehicle power supply 30, as necessary to implement the elements of the method 348, suspect vent module 240, and/or communication control module 242, as described herein.

In additional or alternative configurations, the method 348 may further include and/or the communication control module 242 may be further configured to establish the two-way communication link between the remote device 24 and the surrounding of the occupied vehicle 10. For example, the corrective action(s) may include establishing a two-way communication link between the remote device 24 (e.g., one or more included speakers and/or microphones thereof) and the external speaker(s) 17 and/or the external sensor(s) 18 configured as the external microphone(s). Furthermore or alternatively, the two-way communication link between the operator/remote device 24 and the vehicle 10 or system 100 may include a video two-way communication link. Thus, the communication link may be additionally or alternatively facilitated by properly configured and arranged external vehicle sensor(s) 18 (e.g., cameras, optical sensors, and the like) and a display provided with the remote device 24 of the operator.

Referring particularly to FIGS. 1-2 and as illustrated, the two-way communication link between the operator/remote device 24 and the vehicle 10, system 100, and/or components or subsystems thereof (e.g., elements 17, 18, 19, 21, 28, and/or 30, as described herein) may be provided via a local area network, e.g., a wireless connection(s) with the vehicle 10, system 100, and/or included wireless receivers, transmitters, transceivers, or the like, such that the two-way communication link is provided through the control unit 22 (FIG. 1) and/or another included controller, processing unit, or the like provided in the vehicle 10.

In further or other embodiments, the two-way communication link between the operator/remote device 24 and the vehicle 10, system 100, and/or components or subsystems thereof may be provided, at least in part, via a wide area network 246 such as a mobile/cellular network, the internet of things, or the like. For example, the wide area network 246 may be utilized when a distance between the vehicle 10 and the remote device 24 is outside of a range of the applicable local area radio transmitters, receivers, transceivers, or the like. In such embodiments and situations, the communication control module 242 and/or control unit 22 may facilitate, request, or send appropriate communication instructions to cause the two-way communication link through the wide area network 246. In some such embodiments and situations, the communication control module 242 and/or control unit 22 may provide a warning, alert, or the like via display(s) of the remote device 24 that such wide area two-way communication link may consume or utilize data of a cellular data plan associated with the remote device 24, the system 100, and/or the mobile device(s) 20 of the occupant(s) of the vehicle 10. Thus, it should be appreciated that a wide area connection of the mobile device(s) 20 of the occupant(s) may be utilized to facilitate communication between the remote device 24 and the system 100 and/or control unit 22 when necessary, e.g., when the vehicle 10 does not include its own cellular data plan or does not have enough remaining data to provide such wide area network 246 connectivity.

It is to be recognized that, depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

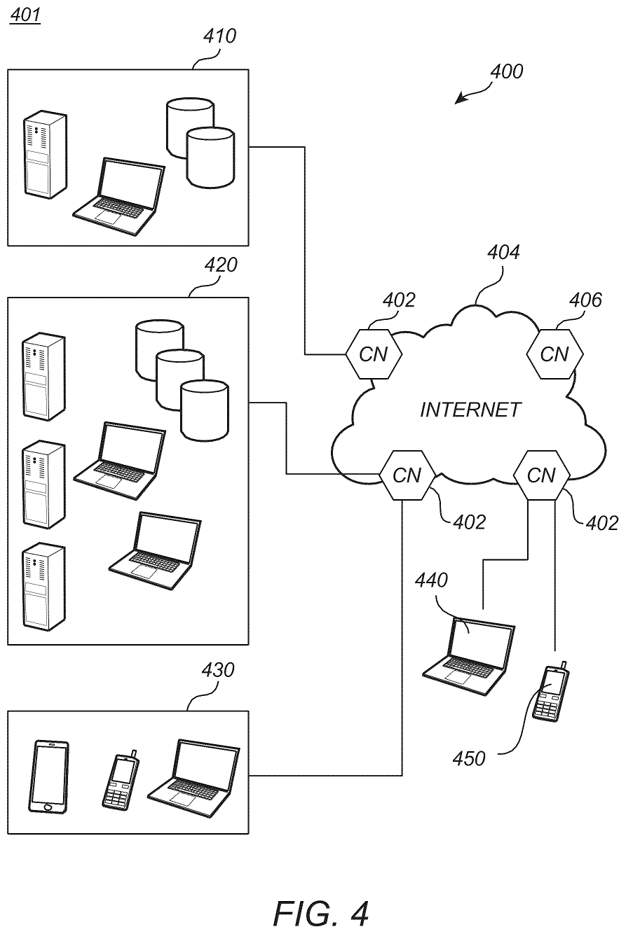

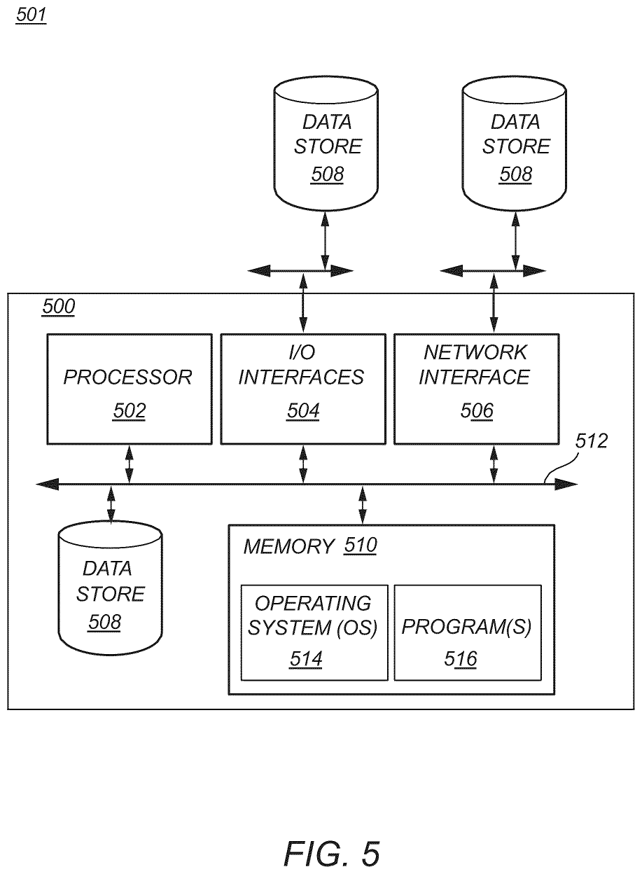

FIG. 4 is a network diagram of a cloud-based system 400 for implementing various cloud-based services of the present disclosure. The cloud-based system 400 includes one or more cloud nodes (CNs) 402 communicatively coupled to the Internet 404 or the like. The cloud nodes 402 may be implemented as a server 500 (as illustrated in FIG. 5) or the like and can be geographically diverse from one another, such as located at various data centers around the country or globe. Further, the cloud-based system 400 can include one or more central authority (CA) nodes 406, which similarly can be implemented as the server 400 and be connected to the CNs 402. For illustration purposes, the cloud-based system 400 can connect to a regional office 410, headquarters 420, various employee's homes 430, laptops/desktops 440, and mobile devices 450, each of which can be communicatively coupled to one of the CNs 402. These locations 410, 420, and 430, and devices 440 and 450 are shown for illustrative purposes, and those skilled in the art will recognize there are various access scenarios to the cloud-based system 400, all of which are contemplated herein. The devices 440 and 450 can be so-called road warriors, i.e., users off-site, on-the-road, etc. The cloud-based system 400 can be a private cloud, a public cloud, a combination of a private cloud and a public cloud (hybrid cloud), or the like.

Again, the cloud-based system 400 can provide any functionality through services, such as software-as-a-service (SaaS), platform-as-a-service, infrastructure-as-a-service, security-as-a-service, Virtual Network Functions (VNFs) in a Network Functions Virtualization (NFV) Infrastructure (NFVI), etc. to the locations 410, 420, and 430 and devices 440 and 450. Previously, the Information Technology (IT) deployment model included enterprise resources and applications stored within an enterprise network (i.e., physical devices), behind a firewall, accessible by employees on site or remote via Virtual Private Networks (VPNs), etc. The cloud-based system 400 is replacing the conventional deployment model. The cloud-based system 400 can be used to implement these services in the cloud without requiring the physical devices and management thereof by enterprise IT administrators.

Cloud computing systems and methods abstract away physical servers, storage, networking, etc., and instead offer these as on-demand and elastic resources. The National Institute of Standards and Technology (NIST) provides a concise and specific definition which states cloud computing is a model for enabling convenient, on-demand network access to a shared pool of configurable computing resources (e.g., networks, servers, storage, applications, and services) that can be rapidly provisioned and released with minimal management effort or service provider interaction. Cloud computing differs from the classic client-server model by providing applications from a server that are executed and managed by a client's web browser or the like, with no installed client version of an application required. Centralization gives cloud service providers complete control over the versions of the browser-based and other applications provided to clients, which removes the need for version upgrades or license management on individual client computing devices. The phrase “software as a service” (SaaS) is sometimes used to describe application programs offered through cloud computing. A common shorthand for a provided cloud computing service (or even an aggregation of all existing cloud services) is “the cloud.” The cloud-based system 400 is illustrated herein as one example embodiment of a cloud-based system, and those of ordinary skill in the art will recognize the systems and methods described herein are not necessarily limited thereby.

FIG. 5 is a block diagram of a server 500, which may be used in the cloud-based system 400 (FIG. 4), in other systems, or stand-alone. For example, the CNs 402 (FIG. 4) and the central authority nodes 406 (FIG. 4) may be formed as one or more of the servers 500. The server 500 may be a digital computer that, in terms of hardware architecture, generally includes a processor 502, input/output (I/O) interfaces 504, a network interface 506, a data store 508, and memory 510. It should be appreciated by those of ordinary skill in the art that FIG. 5 depicts the server 500 in an oversimplified manner, and a practical embodiment may include additional components and suitably configured processing logic to support known or conventional operating features that are not described in detail herein. The components (502, 504, 506, 508, and 510) are communicatively coupled via a local interface 512. The local interface 512 may be, for example, but is not limited to, one or more buses or other wired or wireless connections, as is known in the art. The local interface 512 may have additional elements, which are omitted for simplicity, such as controllers, buffers (caches), drivers, repeaters, and receivers, among many others, to enable communications. Further, the local interface 512 may include address, control, and/or data connections to enable appropriate communications among the aforementioned components.

The processor 502 is a hardware device for executing software instructions. The processor 502 may be any custom made or commercially available processor, a central processing unit (CPU), an auxiliary processor among several processors associated with the server 500, a semiconductor-based microprocessor (in the form of a microchip or chipset), or generally any device for executing software instructions. When the server 500 is in operation, the processor 502 is configured to execute software stored within the memory 510, to communicate data to and from the memory 510, and to generally control operations of the server 500 pursuant to the software instructions. The I/O interfaces 504 may be used to receive user input from and/or for providing system output to one or more devices or components.

The network interface 506 may be used to enable the server 500 to communicate on a network, such as the Internet 404 (FIG. 4). The network interface 506 may include, for example, an Ethernet card or adapter (e.g., 10BaseT, Fast Ethernet, Gigabit Ethernet, or 10 GbE) or a Wireless Local Area Network (WLAN) card or adapter (e.g., 802.11a/b/g/n/ac). The network interface 506 may include address, control, and/or data connections to enable appropriate communications on the network. A data store 508 may be used to store data. The data store 508 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 508 may incorporate electronic, magnetic, optical, and/or other types of storage media. In one example, the data store 508 may be located internal to the server 500, such as, for example, an internal hard drive connected to the local interface 512 in the server 500. Additionally, in another embodiment, the data store 508 may be located external to the server 500 such as, for example, an external hard drive connected to the I/O interfaces 504 (e.g., a SCSI or USB connection). In a further embodiment, the data store 508 may be connected to the server 500 through a network, such as, for example, a network-attached file server.

The memory 510 may include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 510 may incorporate electronic, magnetic, optical, and/or other types of storage media. Note that the memory 510 may have a distributed architecture, where various components are situated remotely from one another but can be accessed by the processor 502. The software in memory 510 may include one or more software programs, each of which includes an ordered listing of executable instructions for implementing logical functions. The software in the memory 510 includes a suitable operating system (O/S) 514 and one or more programs 516. The operating system 514 essentially controls the execution of other computer programs, such as the one or more programs 516, and provides scheduling, input-output control, file and data management, memory management, and communication control and related services. The one or more programs 516 may be configured to implement the various processes, algorithms, methods, techniques, etc. described herein.

It will be appreciated that some embodiments described herein may include one or more generic or specialized processors (“one or more processors”) such as microprocessors; central processing units (CPUs); digital signal processors (DSPs); customized processors such as network processors (NPs) or network processing units (NPUs), graphics processing units (GPUs), or the like; field programmable gate arrays (FPGAs); and the like along with unique stored program instructions (including both software and firmware) for control thereof to implement, in conjunction with certain non-processor circuits, some, most, or all of the functions of the methods and/or systems described herein. Alternatively, some or all functions may be implemented by a state machine that has no stored program instructions, or in one or more application-specific integrated circuits (ASICs), in which each function or some combinations of certain of the functions are implemented as custom logic or circuitry. Of course, a combination of the aforementioned approaches may be used. For some of the embodiments described herein, a corresponding device in hardware and optionally with software, firmware, and a combination thereof can be referred to as “circuitry configured or adapted to,” “logic configured or adapted to,” etc. perform a set of operations, steps, methods, processes, algorithms, functions, techniques, etc. on digital and/or analog signals as described herein for the various embodiments.

Moreover, some embodiments may include a non-transitory computer-readable storage medium having computer-readable code stored thereon for programming a computer, server, appliance, device, processor, circuit, etc. each of which may include a processor to perform functions as described and claimed herein. Examples of such computer-readable storage mediums include, but are not limited to, a hard disk, an optical storage device, a magnetic storage device, a Read-Only Memory (ROM), a Programmable Read-Only Memory (PROM), an Erasable Programmable Read-Only Memory (EPROM), an Electrically Erasable Programmable Read-Only Memory (EEPROM), flash memory, and the like. When stored in the non-transitory computer-readable medium, software can include instructions executable by a processor or device (e.g., any type of programmable circuitry or logic) that, in response to such execution, cause a processor or the device to perform a set of operations, steps, methods, processes, algorithms, functions, techniques, etc. as described herein for the various embodiments.

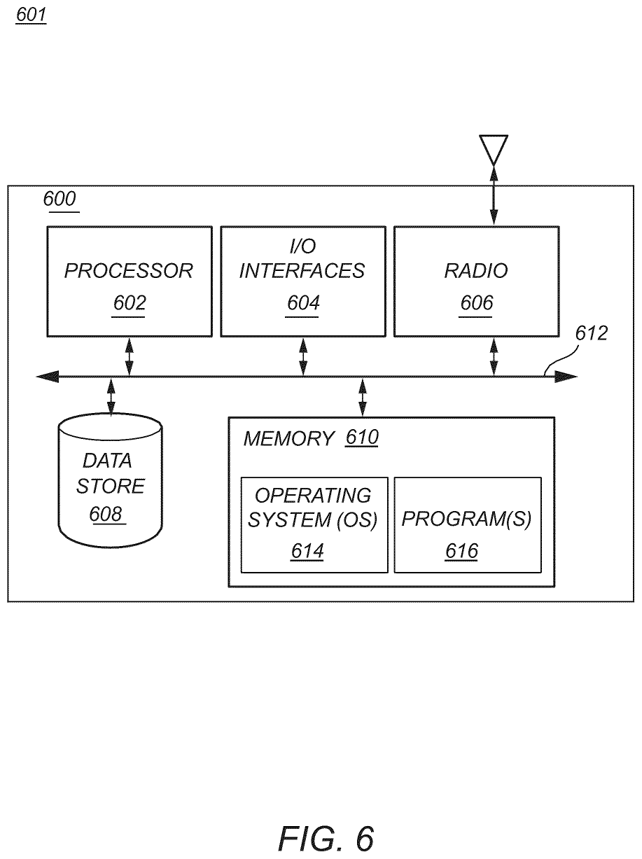

FIG. 6 is a block diagram of a user device 600, which may be used in the cloud-based system 400 (FIG. 4), as part of a network, or stand-alone. Again, the user device 600 can be a vehicle (e.g., one or more control units thereof), a smartphone, a tablet, a smartwatch, an Internet of Things (IoT) device, a laptop, a virtual reality (VR) headset, etc.

The user device 600 can be a digital device that, in terms of hardware architecture, generally includes a processor 602, I/O interfaces 604, a radio 606, a data store 608, and memory 610. It should be appreciated by those of ordinary skill in the art that FIG. 6 depicts the user device 600 in an oversimplified manner, and a practical embodiment may include additional components and suitably configured processing logic to support known or conventional operating features that are not described in detail herein. The components (602, 604, 606, 608, and 610) are communicatively coupled via a local interface 612. The local interface 612 can be, for example, but is not limited to, one or more buses or other wired or wireless connections, as is known in the art. The local interface 612 can have additional elements, which are omitted for simplicity, such as controllers, buffers (caches), drivers, repeaters, and receivers, among many others, to enable communications. Further, the local interface 612 may include address, control, and/or data connections to enable appropriate communications among the aforementioned components.

The processor 602 is a hardware device for executing software instructions. The processor 602 can be any custom made or commercially available processor, a CPU, an auxiliary processor among several processors associated with the user device 600, a semiconductor-based microprocessor (in the form of a microchip or chipset), or generally any device for executing software instructions. When the user device 600 is in operation, the processor 602 is configured to execute software stored within the memory 610, to communicate data to and from the memory 610, and to generally control operations of the user device 600 pursuant to the software instructions. In an embodiment, the processor 602 may include a mobile optimized processor such as optimized for power consumption and mobile applications. The I/O interfaces 604 can be used to receive user input from and/or for providing system output. User input can be provided via, for example, a keypad, a touch screen, a scroll ball, a scroll bar, buttons, a barcode scanner, and the like. System output can be provided via a display device such as a liquid crystal display (LCD), touch screen, and the like.

The radio 606 enables wireless communication to an external access device or network. Any number of suitable wireless data communication protocols, techniques, or methodologies can be supported by the radio 606, including any protocols for wireless communication. The data store 608 may be used to store data. The data store 608 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 608 may incorporate electronic, magnetic, optical, and/or other types of storage media.

Again, the memory 610 may include any of volatile memory elements (e.g., random access memory (RAM, such as DRAM, SRAM, SDRAM, etc.)), nonvolatile memory elements (e.g., ROM, hard drive, etc.), and combinations thereof. Moreover, the memory 610 may incorporate electronic, magnetic, optical, and/or other types of storage media. Note that the memory 610 may have a distributed architecture, where various components are situated remotely from one another, but can be accessed by the processor 602. The software in memory 610 can include one or more software programs, each of which includes an ordered listing of executable instructions for implementing logical functions. In the example of FIG. 6, the software in the memory 610 includes a suitable operating system 614 and programs 616. The operating system 614 essentially controls the execution of other computer programs and provides scheduling, input-output control, file and data management, memory management, and communication control and related services. The programs 616 may include various applications, add-ons, etc. configured to provide end user functionality with the user device 600. For example, example programs 616 may include, but not limited to, a web browser, social networking applications, streaming media applications, games, mapping and location applications, electronic mail applications, financial applications, and the like. In a typical example, the end-user typically uses one or more of the programs 616 along with a network, such as the cloud-based system 400 (FIG. 4).

Again, embodiments of the disclosed systems and methods facilitate communication between an occupied vehicle and a remote device of an operator of the vehicle outside of the surroundings or immediate surroundings of the vehicle. A suspect event identification module and associated method elements can determine that a pedestrian has approached a door of the vehicle, that the pedestrian is observing an occupant of the vehicle, that the pedestrian is knocking on an exterior surface of the occupied vehicle such as a widow, and/or that the pedestrian is communicating or attempting to communicate with the occupant(s) of the vehicle based on external vehicle sensors. In several embodiments, microphone(s), audio sensor(s), or the like may be utilized to determine the occurrence of any of these events or other suspect events based on an audio environment of the surrounding of the occupied vehicle. Thereafter, a communication module can communicate a signal to the remote device of the operator of vehicle. In various embodiments and configurations, the suspect event identification module may only identify the suspect event and/or the signal may only be communicated to the remote device after determining that the vehicle is occupied. The signal communicated to the remote device may include an alert, an audio recording, an image, and/or a video recording of the surroundings of the vehicle or the pedestrian.

In various situations and configurations, the communication module may further receive a response signal communicated from the remote device indicating one or more corrective actions desired by the operator. For example, in the case that operator of vehicle is already aware of the occupant(s) and that the occupants are safe and comfortable (e.g., the AC has been left on with the car running), the corrective action may include playing a prerecorded message indicating the same or establishing a two-way communication between the remote device and the surrounding of the vehicle (e.g., an audio two-way communication and/or a communication including video such as at least video of the exterior of the vehicle). Alternatively, such two-way communication may be utilized to update the operator that the occupant(s) is not safe and/or comfortable within the vehicle. In the event that the occupant(s) is not safe and comfortable within the vehicle, the corrective action(s) may further or alternatively include one or more of opening a window of the vehicle, unlocking a door of the vehicle, activating a climate control system of the vehicle, or implementing a predetermined setting of the climate control system.

Although the present disclosure is illustrated and described with reference to embodiments and examples thereof, it will be readily apparent to those of ordinary skill in the art that other embodiments and examples may perform similar functions and/or achieve like results. All such equivalent embodiments and examples are within the spirit and scope of the present disclosure, are contemplated thereby, and are intended to be covered by the following, non-limiting Clauses and/or Claims for all purposes.

Clause 1: A vehicle comprising:
at least one external vehicle environmental sensor; and
a system for remote control of the vehicle.

Clause 2: The vehicle of Clause 1, wherein at least one of the vehicle or the system for remote control of the vehicle comprises a suspect event identification module.

Clause 3: The vehicle of Clause 1 or Clause 2, wherein at least one of the vehicle or the system for remote control of the vehicle comprises a communication module.

Clause 4: The vehicle of any one of the previous clauses, wherein the suspect event identification module comprises instructions stored in at least one memory and executable by one or more processors to cause the suspect event identification module to determine the occurrence of a suspect event at the vehicle based, at least in part, on data indicative of an audio environment of a surrounding of the vehicle.

Clause 5: The vehicle of any one of the previous clauses, wherein the communication module comprises instructions stored in at least one memory and executable by one or more processors to cause the communication module to communicate, in response to the determination of the suspect event, an initial signal to a remote device of an operator of the vehicle, the operator outside of the vehicle.

Clause 6: The vehicle of one of the previous clauses, wherein the vehicle further comprises at least one internal vehicle occupant sensor.

Clause 7: The vehicle of one of the previous clauses, wherein the suspect event identification module comprises instructions stored in at least one memory and executable by one or more processors to cause the suspect event identification module to determine a status of the vehicle as occupied based at least in part on a signal communicated from the at least one internal vehicle occupant sensor.

Clause 8: The vehicle of one of the previous clauses, wherein the suspect event identification module comprises instructions stored in at least one memory and executable by one or more processors to cause the suspect event identification module to determine, in response to the determination of the vehicle as occupied, the occurrence of a suspect event at the vehicle based, at least in part, on data indicative of an audio environment of a surrounding of the vehicle.

Clause 9: A system for remote control of an occupied vehicle, the system comprising:
at least one external vehicle environmental sensor;
a suspect event identification module comprising instructions stored in at least one memory and executable by one or more processors to cause the suspect event identification module to:
   determine the occurrence of a suspect event at the occupied vehicle based, at least in part, on data indicative of an audio environment of a surrounding of the occupied vehicle; and
a communication module comprising instructions stored in at least one memory and executable by one or more processors to cause the communication module to:
   communicate, in response to the determination of the suspect event, an initial signal to a remote device of an operator of the occupied vehicle, the operator outside of the occupied vehicle.

Clause 10: The system of any one of the previous clauses, wherein the communication module further comprises instructions stored in the at least one memory and executable by the one or more processors to cause the communication module to receive a response signal communicated from the remote device subsequent to communicating the initial signal, the response signal indicative of at least one corrective action to be performed by at least one component of the occupied vehicle

Clause 11: The system of any one of the previous clauses, wherein the at least one external vehicle environmental sensor comprises at least one external vehicle microphone.

Clause 12: The system of any one of the previous clauses, wherein the system further comprises at least one external vehicle speaker.

Clause 13: The system of any one of the previous clauses, wherein the corrective action comprises at least one of playing a prerecorded message via the at least one external vehicle speaker or establishing a two-way communication link between the remote device and the surrounding of the occupied vehicle via the at least one external vehicle speaker and the at least one external vehicle microphone.

Clause 14: The system of any one of the previous clauses, wherein the at least one external vehicle environmental sensor comprises at least one external vehicle camera.

Clause 15: The system of any one of the previous clauses, wherein the corrective action comprises establishing a two-way communication link between the remote device and the surrounding of the occupied vehicle.

Clause 16: The system of any one of the previous clauses, wherein the corrective action comprises establishing a two-way communication link between the remote device and the surrounding of the occupied vehicle via one or more of the at least one external vehicle speaker, the at least one external vehicle microphone, and the at least one external vehicle camera.

Clause 17: The system of any one of the previous clauses, wherein the corrective action comprises establishing a two-way communication link between the remote device and the surrounding of the occupied vehicle via the at least one external vehicle speaker, the at least one external vehicle microphone, and the at least one external vehicle camera.

Clause 18: The system of any one of the previous clauses, wherein the corrective action comprises at least one of opening a window of the occupied vehicle, unlocking a door of the occupied vehicle, activating a climate control system of the occupied vehicle, or implementing a predetermined setting of the climate control system of the occupied vehicle.

Clause 19: The system of any one of the previous clauses, further comprising at least one internal vehicle occupant sensor.

Clause 20: The system of any one of the previous clauses, wherein the suspect event identification module further comprises instructions stored in the at least one memory and executable by the one or more processors to cause the suspect event identification module to determine a status of the occupied vehicle as occupied based at least in part on a signal communicated from the at least one internal vehicle occupant sensor.

Clause 21: The system of any one of the previous clauses, wherein the initial signal is communicated to the remote device subsequent to determining the status of the occupied vehicle as occupied.

Clause 22: The system of any one of the previous clauses, wherein the suspect event comprises at least one of a pedestrian observing an occupant of the occupied vehicle, the pedestrian knocking on an exterior surface of the occupied vehicle, or the pedestrian communicating with the occupant of the occupied vehicle.

Clause 23: The system of any one of the previous clauses, wherein the initial signal comprises data indicative of an image or video of at least one of the suspect event, the surrounding of the occupied vehicle, or at least one pedestrian associated with the suspect event.

Clause 24: The system of any one of the previous clauses, further comprising at least one internal vehicle camera.

Clause 25: The system of any one of the previous clauses, wherein the initial signal comprises data indicative of an image or video of at least one of an interior of the occupied vehicle or an occupant of the occupied vehicle.

Clause 26: The system of any one of the previous clauses, wherein the remote device comprises at least one of a key fob, a mobile device, or a personal computer.

Clause 27: The system of any one of the previous clauses, wherein determining the occurrence of the suspect event at the occupied vehicle further comprises determining that the surrounding of the occupied vehicle is a suspect area.

Clause 28: A non-transitory computer-readable medium comprising instructions stored in at least one memory that, when executed by one or more processors, cause the one or more processors to carry out steps comprising:
determining a status of a parked vehicle as an occupied vehicle,
receiving, in response to the determination of the occupied vehicle, a signal communicated from at least one external vehicle environmental sensor of the parked vehicle;
determining the occurrence of a suspect event at the parked vehicle based, at least in part, on an audio environment of a surrounding of the parked vehicle indicated by the received signal; and
communicating, in response to the determination of the suspect event, an initial signal to a remote device of an operator of the parked vehicle, the operator outside of the parked vehicle.

Clause 29: The non-transitory computer-readable medium of any one of the previous clauses, wherein the steps further comprise receiving a response signal communicated from the remote device subsequent to communicating the initial signal.

Clause 30: The non-transitory computer-readable medium of any one of the previous clauses, wherein the response signal indicative of at least one corrective action to be performed.

Clause 31: The non-transitory computer-readable medium of any one of the previous clauses, wherein the steps further comprise causing the at least one corrective action to be performed via at least one component of the parked vehicle.

Clause 32: The non-transitory computer-readable medium of any one of the previous clauses, wherein the at least one corrective action comprises playing a prerecorded message via at least one external vehicle speaker of the parked vehicle.

Clause 33: The non-transitory computer-readable medium of any one of the previous clauses, wherein the at least one external vehicle environmental sensor comprises at least one external vehicle microphone.

Clause 34: The non-transitory computer-readable medium of any one of the previous clauses, wherein the at least one corrective action comprises establishing a two-way communication link between the remote device and the surrounding of the parked vehicle.

Clause 35: The non-transitory computer-readable medium of any one of the previous clauses, wherein the at least one corrective action comprises establishing a two-way communication link between the remote device and the surrounding of the parked vehicle via at least one external vehicle speaker and the at least one external vehicle microphone.

Clause 36: The non-transitory computer-readable medium of any one of the previous clauses, wherein the at least one external vehicle environmental sensor comprises at least one external vehicle camera.

Clause 37: The non-transitory computer-readable medium of any one of the previous clauses, wherein the at least one corrective action comprises establishing a two-way communication link between the remote device and the surrounding of the parked vehicle via one or more of the at least one external vehicle microphone, the at least one external vehicle camera, and at least one external vehicle speaker.

Clause 38: The non-transitory computer-readable medium of any one of the previous clauses, wherein the at least one corrective action comprises establishing a two-way communication link between the remote device and the surrounding of the parked vehicle via the at least one external vehicle microphone, the at least one external vehicle camera, and at least one external vehicle speaker.

Clause 39: The non-transitory computer-readable medium of any one of the previous clauses, wherein the at least one corrective action comprises at least one of opening a window of the parked vehicle, unlocking a door of the parked vehicle, activating a climate control system of the parked vehicle, or implementing a predetermined setting of the climate control system of the parked vehicle.

Clause 40: The non-transitory computer-readable medium of any one of the previous clauses, wherein the suspect event comprises at least one of a pedestrian observing an occupant of the parked vehicle, the pedestrian knocking on an exterior surface of the parked vehicle, or the pedestrian communicating with the occupant of the parked vehicle.

Clause 40: The non-transitory computer-readable medium of any one of the previous clauses, wherein the initial signal comprises data indicative of an image or video of at least one of the suspect event, the surrounding of the parked vehicle, or at least one pedestrian associated with the suspect event.

Clause 41: The non-transitory computer-readable medium of any one of the previous clauses, wherein the initial signal comprises data indicative of an image or video of at least one of an interior of the parked vehicle or an occupant of the parked vehicle.

Clause 42: The non-transitory computer-readable medium of any one of the previous clauses, wherein the parked vehicle includes at least one internal vehicle camera.

Clause 43: The non-transitory computer-readable medium of any one of the previous clauses, wherein the initial signal comprises data indicative of an image or video of at least one of an interior of the parked vehicle or an occupant of the parked vehicle based on a signal communicated from at least one internal vehicle camera.

What is claimed is:

1. A system for remote control of an occupied vehicle, the system comprising:
at least one external vehicle environmental sensor;
a suspect event identification module comprising instructions stored in at least one memory and executable by one or more processors to cause the suspect event identification module to:
determine the occurrence of a suspect event at the occupied vehicle based, at least in part, on data indicative of an audio environment of a surrounding of the occupied vehicle; and
a communication module comprising instructions stored in at least one memory and executable by one or more processors to cause the communication module to:
communicate, in response to the determination of the suspect event, an initial signal to a remote device of an operator of the occupied vehicle, the operator outside of the occupied vehicle.

2. The system of claim 1, wherein the communication module further comprises instructions stored in the at least one memory and executable by the one or more processors to cause the communication module to:
receive a response signal communicated from the remote device subsequent to communicating the initial signal, the response signal indicative of at least one corrective action to be performed by at least one component of the occupied vehicle.

3. The system of claim 2, wherein the at least one external vehicle environmental sensor comprises at least one external vehicle microphone, and the system further comprises at least one external vehicle speaker, and wherein the corrective action comprises at least one of playing a prerecorded message via the at least one external vehicle speaker or establishing a two-way communication link between the remote device and the surrounding of the occupied vehicle via the at least one external vehicle speaker and the at least one external vehicle microphone.

4. The system of claim 2, wherein the at least one external vehicle environmental sensor comprises at least one external vehicle microphone and at least one external vehicle camera, and the system further comprising at least one external vehicle speaker, and wherein the corrective action comprises establishing a two-way communication link between the remote device and the surrounding of the occupied vehicle via the at least one external vehicle speaker, the at least one external vehicle microphone, and the at least one external vehicle camera.

5. The system of claim 2, wherein the corrective action comprises at least one of opening a window of the occupied vehicle, unlocking a door of the occupied vehicle, activating a climate control system of the occupied vehicle, or implementing a predetermined setting of the climate control system of the occupied vehicle.

6. The system of claim 1, further comprising at least one internal vehicle occupant sensor, and wherein the suspect event identification module further comprises instructions stored in the at least one memory and executable by the one or more processors to cause the suspect event identification module to:
determine a status of the occupied vehicle as occupied based at least in part on a signal communicated from the at least one internal vehicle occupant sensor, and
wherein the initial signal is communicated to the remote device subsequent to determining the status of the occupied vehicle as occupied.

7. The system of claim 1, wherein the suspect event comprises at least one of a pedestrian observing an occupant of the occupied vehicle, the pedestrian knocking on an exterior surface of the occupied vehicle, or the pedestrian communicating with the occupant of the occupied vehicle.

8. The system of claim 1, wherein the at least one external vehicle environmental sensor comprises at least one external vehicle camera, wherein the initial signal comprises data indicative of an image or video of at least one of the suspect event, the surrounding of the occupied vehicle, or at least one pedestrian associated with the suspect event.

9. The system of claim 1, further comprising at least one internal vehicle camera, and wherein the initial signal comprises data indicative of an image or video of at least one of an interior of the occupied vehicle or an occupant of the occupied vehicle.

10. The system of claim 1, wherein the remote device comprises at least one of a key fob, a mobile device, or a personal computer.

11. The system of claim 1, wherein determining the occurrence of the suspect event at the occupied vehicle further comprises determining that the surrounding of the occupied vehicle is a suspect area.

12. A non-transitory computer-readable medium comprising instructions stored in at least one memory that, when executed by one or more processors, cause the one or more processors to carry out steps comprising:
determining a status of a parked vehicle as an occupied vehicle,
receiving, in response to the determination of the occupied vehicle, a signal communicated from at least one external vehicle environmental sensor of the parked vehicle;
determining the occurrence of a suspect event at the parked vehicle based, at least in part, on an audio environment of a surrounding of the parked vehicle indicated by the received signal; and
communicating, in response to the determination of the suspect event, an initial signal to a remote device of an operator of the parked vehicle, the operator outside of the parked vehicle.

13. The non-transitory computer-readable medium of claim 12, wherein the steps further comprise:
receiving a response signal communicated from the remote device subsequent to communicating the initial signal, the response signal indicative of at least one corrective action to be performed; and
causing the at least one corrective action to be performed via at least one component of the parked vehicle.

14. The non-transitory computer-readable medium of claim 13, wherein the at least one corrective action comprises playing a prerecorded message via at least one external vehicle speaker of the parked vehicle.

15. The non-transitory computer-readable medium of claim 13, wherein the at least one external vehicle environmental sensor comprises at least one external vehicle microphone, and wherein the at least one corrective action comprises establishing a two-way communication link between the remote device and the surrounding of the parked vehicle via at least one external vehicle speaker and the at least one external vehicle microphone.

16. The non-transitory computer-readable medium of claim 13, wherein the at least one external vehicle environmental sensor comprises at least one external vehicle microphone and at least one external vehicle camera, and wherein the at least one corrective action comprises establishing a two-way communication link between the remote device and the surrounding of the parked vehicle via the at least one external vehicle microphone, the at least one external vehicle camera, and at least one external vehicle speaker.

17. The non-transitory computer-readable medium of claim 13, wherein the at least one corrective action comprises at least one of opening a window of the parked vehicle, unlocking a door of the parked vehicle, activating a climate control system of the parked vehicle, or implementing a predetermined setting of the climate control system of the parked vehicle.

18. The non-transitory computer-readable medium of claim 12, wherein the suspect event comprises at least one of a pedestrian observing an occupant of the parked vehicle, the pedestrian knocking on an exterior surface of the parked vehicle, or the pedestrian communicating with the occupant of the parked vehicle.

19. The non-transitory computer-readable medium of claim 12, wherein the at least one external vehicle environmental sensor comprises at least one external vehicle camera, wherein the initial signal comprises data indicative of an image or video of at least one of the suspect event, the surrounding of the parked vehicle, or at least one pedestrian associated with the suspect event.

20. A vehicle comprising:
at least one external vehicle environmental sensor;
at least one internal vehicle occupant sensor;
a suspect event identification module comprising instructions stored in at least one memory and executable by one or more processors to cause the suspect event identification module to:
determine a status of the vehicle as occupied based at least in part on a signal communicated from the at least one internal vehicle occupant sensor; and
determine, in response to the determination of the vehicle as occupied, the occurrence of a suspect event at the vehicle based, at least in part, on data indicative of an audio environment of a surrounding of the vehicle; and
a communication module comprising instructions stored in at least one memory and executable by one or more processors to cause the communication module to:
communicate, in response to the determination of the suspect event, an initial signal to a remote device of an operator of the vehicle, the operator outside of the vehicle.
